(19) United States
(12) Patent Application Publication
(10) Pub. No.: US 2017/0254455 A1
(43) Pub. Date: Sep. 7, 2017

(54) FOLDED SEALING RING AND DEVICE FOR DETECTING COMPONENTS OF A FOLDED SEALING RING

(71) Applicant: FR. JACOB SÖHNE GMBH & CO. KG, Porta Westfalica (DE)

(72) Inventors: Bernhard BRENDEL, Espelkamp (DE); Uwe SCHMIDT, Mainaschaff (DE); Uwe BRAUN, Nienburg (DE); Patrick JACOB, Minden (DE)

(21) Appl. No.: 15/513,220

(22) PCT Filed: Sep. 23, 2014
(86) PCT No.: PCT/EP2014/070213

§ 371 Date: May 24, 2017

(51) Int. Cl. F16L 23/22; F16L 23/16

(52) U.S. Cl. CPC F16L 23/22; F16L 23/162; F16J 15/02

(57) ABSTRACT

A flanged sealing ring which is used to seal a pipe connection is produced from a material having a metal fraction distributed substantially homogeneously in the flanged sealing ring. The flanged sealing ring can be used in a device for detecting components of a flanged sealing ring in a pipeline system that includes a plurality of pipes, at least two of which are held against each other at a flange in such a way that sealing is effected by a flanged sealing ring. Using a metal detector and a gate for removing a metal-containing substance from the pipeline, which gate is arranged behind the metal detector in the conveying direction, the flanged sealing ring can then be detected, and therefore, when components of the flanged sealing ring detach, detection can be performed at the metal detector and discharging can be performed at the gate.

### BACKGROUND AND SUMMARY OF THE INVENTION

Exemplary embodiments of the present invention relate to a flanged sealing ring and a device for detecting components of a flanged sealing ring in a pipeline system with several pipes forming a pipeline for conveying a flow of material.

European patent document EP 1 245 890 discloses a flanged sealing ring tightly connecting two adjoining pipes to each other. A web of the flanged sealing ring is inserted between two flanges of the pipe, whereupon the flanges are compressed by an outer clamping ring, so that the web rests in a sealing manner between the two flanges. Such a connection of two pipes has generally proven to be successful and can be used well especially for pipes of large diameters in industrial installations.

There is the problem in mounting pipeline systems, however, that flanged sealing rings can fall into a pipe and the removal of the flanged sealing ring from the pipeline system can cause considerable dismantling costs. That is why residues of flanged sealing rings can be contained in pipeline systems after crushing in the production process. Especially in the field of the food and pharmaceutical industry it is necessary to observe the highest levels of purity, which means that contamination is unacceptable.

It is therefore the object of the present invention to provide a flanged sealing ring and a device for detecting components of a flanged sealing ring, by means of which a contamination in a pipeline system can be avoided securely.

A flanged sealing ring is provided in accordance with the invention, which is made from a material having a metallic fraction, wherein the metallic fraction is distributed substantially homogeneously in the flanged sealing ring. Detection can thus be carried out on a metal detector, irrespective of the piece of the flanged sealing ring that has inadvertently reached the production process.

The metallic fraction of the material of the flanged sealing ring preferably lies in a range of between 0.5% by weight and 10% by weight, especially 1% by weight to 3% by weight. It can thus be ensured that the remaining properties of the flanged sealing ring, especially the elasticity and the restoring forces, are adequate so as to avoid any disadvantages in the sealing of two pipes. Furthermore, a low fraction of metallic material is adequate to produce detectability. For homogeneous distribution of the metallic fraction, it is preferably made from metallic particles having a size of less than 100 μm, especially less than 60 μm or 40 μm. As a result, the metallic particles also do not disadvantageously impair the surface properties of the flanged sealing ring.

The flanged sealing ring is preferably produced based on an organic material, especially polydimethylsiloxane. This allows the production of the flanged sealing ring in such a way that it is approved for food contact according to the EC Regulation No. 1935/2004 and/or the norm FDA 21 CFR Ch. I, § 177.2600.

To also ensure sealing for the foodstuff area or other areas with high purity requirements, the flanged sealing ring preferably consists of an extruded continuous strand, which is fixed at a seam location by vulcanization. Conventional flanged sealing rings are also extruded and then glued together at the seam or connecting point. However, the use of adhesives is undesirable for many areas because the adhesive can be released, which leads to contamination. The use of adhesives can be avoided by vulcanizing the seam location.

Iron is preferably used as a metallic particle, especially also an iron oxide. Other metallic materials can also be used.

The flanged sealing ring preferably has a Shore hardness A according to DIN 53505-A at 23° C. and d=6 mm of 50 to 65 KME. The tear strength of the material of the flanged sealing ring can be determined according to DIN 53504-S1 at 23° C. and d=2 mm, wherein it then lies in a range of between 7 to 11 N/mm², especially 8 to 10 N/mm².

The elongation at tear of the material of the flanged sealing ring lies at over 300%, especially 400% according to DIN 53504-S1 at 23° C. and d=2 mm. A highly elastic material is thus provided, which ensures secure sealing even under high pressure loads. The rebound resilience according to DIN 53512 is at least 30%, preferably between 45% and 55%, at 23° C. and d=12 mm.

In the device in accordance with the invention, a metal detector and a gate, which is arranged behind the metal detector in the conveying direction, are provided for removing a metal-containing substance from the pipeline, wherein at least one flanged sealing ring is used for producing the pipeline system, which sealing ring is made from a material with a metallic fraction so that during a release of components of the flanged sealing ring a detection can be carried out on the metal detector and a discharge can be carried out at the gate. Even if a component of the flanged sealing ring should be released during mounting or in a later process sequence, it can securely be prevented that the production process is operated with a contaminated material, because by using a flanged sealing ring with a metallic fraction such a contamination by a component of the flanged sealing ring can be recognized on the metal detector upon detachment of such a component or a crushing of the flanged sealing ring. The invention is based on being able to provide additional security against contamination in a production process, wherein even otherwise reliable sealing means cannot lead to any contamination of the production process in the case of damage.

### BRIEF DESCRIPTION OF THE DRAWING FIGURES

The invention will be explained below in closer detail by reference to an embodiment shown in the enclosed drawings, wherein:

FIG. 1 shows a device for detecting components of a flanged sealing ring;

FIG. 2 shows a connection of two adjoining pipes of the device of FIG. 1;

FIG. 3 shows a view of a flanged sealing ring for the pipe connection of FIG. 2;

FIG. 4 shows a view during mounting of the flanged sealing ring, and

FIG. 5 shows a view in the final mounting of the flanged sealing ring.

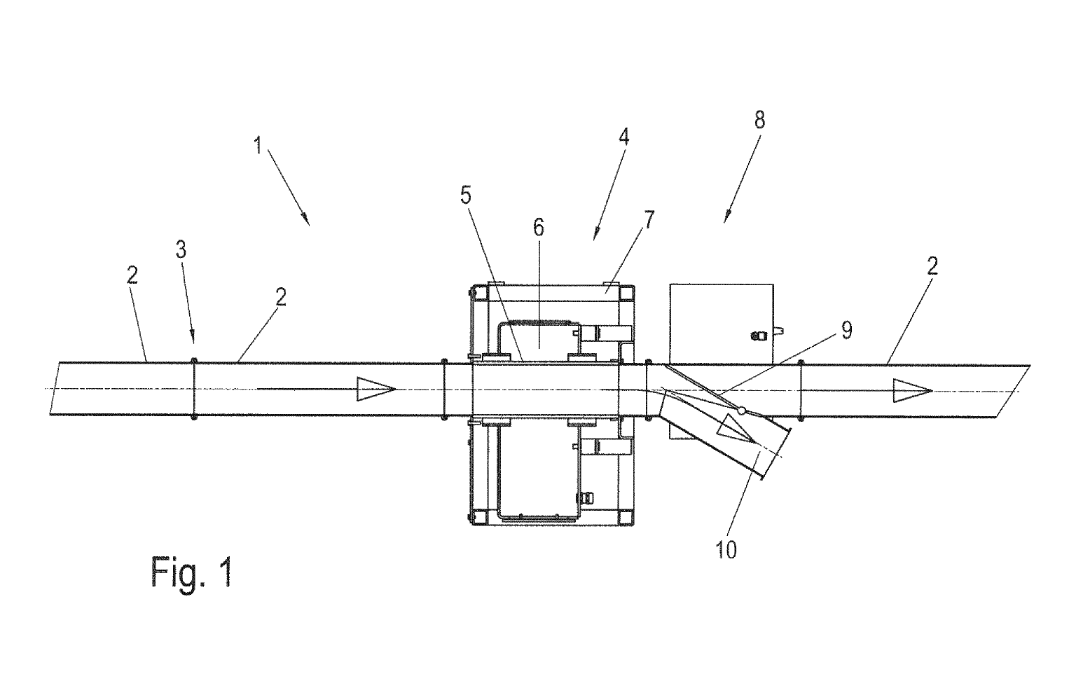

### DETAILED DESCRIPTION

A schematically shown device 1 for detecting components of a flanged sealing ring in the pipeline system can be used for example in a production plant for foodstuff, a chemical or pharmaceutical installation, or a system in another area. The device 1 comprises a plurality of pipes 2, which are connected to each other in a sealing manner at connecting points 3 and form a pipeline system. Pipes 2 need not be cylindrical bodies but can also be pipe bends, pipe branches or other tubular bodies, which are designated as “pipes” in the present application.

A metal detector 4 is provided at at least one point of the pipeline system, which metal detector comprises a pipe 5 made from a non-metallic material, which is surrounded by a detector housing 6. The detector housing 6 can be mounted on a frame 7. A metallic component flowing through the pipe 5 made from a non-metallic material can be detected by the metal detector 4 and can be transmitted to a controller.

The controller is connected to a gate 8, which is arranged in the direction of flow of the product stream behind the metal detector 4. The gate 8 comprises a pivotable flap 9 to conduct the flow of material from the metal detector 4 in normal operation to an adjoining pipe 2. If a metallic component is detected on the metal detector 4, the pivotable flap 9 is switched over via the controller so that the product flow is guided into a branch 10 and can be collected there. This prevents a contaminated section of the flow of the material from reaching the normal production process to the pipe 2.

The metal detector 4 can detect all metallic particles, which can be contained in powder form, in liquid form or as metallic particles in other materials.

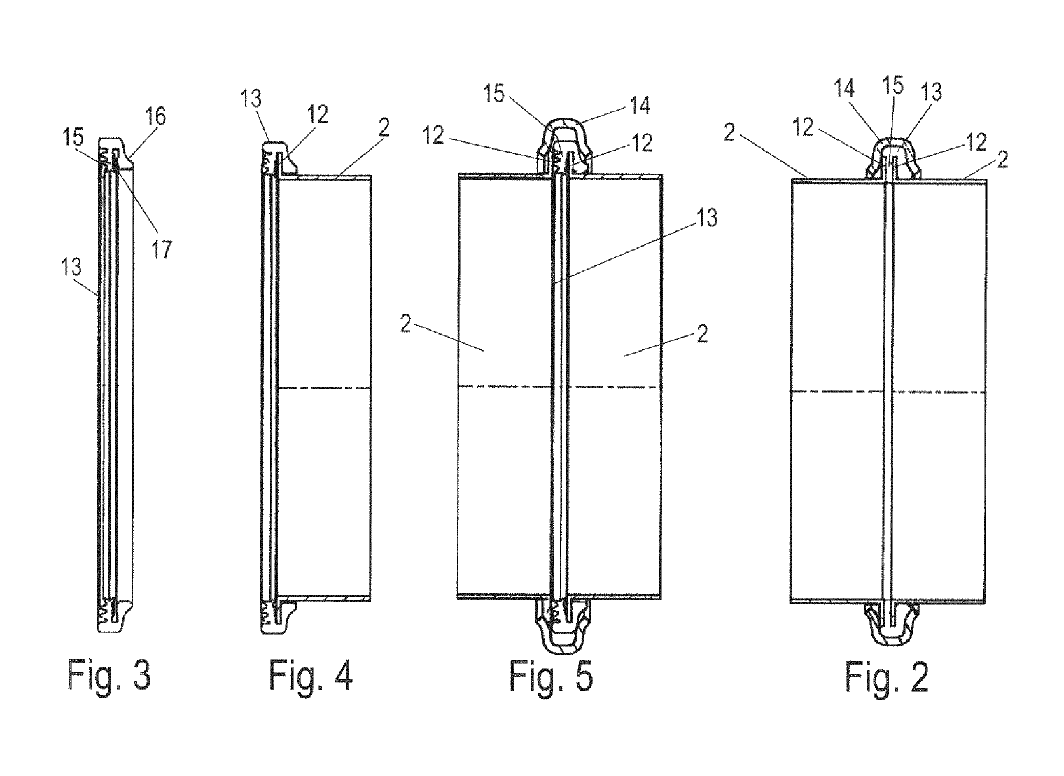

In the pipeline system, at least two adjoining pipes 2 are connected via a flanged sealing ring 13, as shown in FIG. 2. Each pipe 2 comprises a radially protruding annular folded edge or flange 12, to which the flanged sealing ring 13 is fixed. The flanged sealing ring 13 engages with a web between the two flanges 12 of the pipes, wherein the flanges 12 are compressed via an exterior clamping ring 14, as described in European patent document EP 1 245 890.

FIG. 3 shows the flanged sealing ring in detail. The web 15, which engages between the flanges 12 or the folded edges, can be formed in a smooth or profiled manner. The flanged sealing ring 13 is formed in a U-shaped manner in the cross-section and comprises an outer retainer 16 in addition to the web 15, wherein a gap 17 is formed between the web 15 and the retainer 16.

To mount the flanged sealing ring 13, the flange 12 can thus be inserted into the gap 17 of the flanged sealing ring 13, as shown in FIG. 4. The pre-fixed flanged sealing ring 13 can then be used as a contact surface for a flange 12 of a further pipe 2 to subsequently fix the clamping ring 14.

The material of the flanged sealing ring 13 has a metallic fraction, which can be detected in the metal detector 4. The metallic fraction is homogeneously distributed in the material of the flanged sealing ring, so that a detection is possible on the metal detector 4 irrespective of the component that is released from the flanged sealing ring 13 or is crushed in the production process. The fraction of metallic material can be between 0.5% by weight and 10% by weight, especially 1% by weight to 3% by weight. The metallic particles preferably have a size of less than 40 μm, especially less than 30 μm, and are substantially homogeneously distributed in the flanged sealing ring 13.

In order to ensure that the flanged sealing ring, despite the addition of a metallic fraction, has adequate sealing properties, the Shore hardness A can be in the range of between 50 to 65 KME, especially 54 to 58 KME, according to DIN 53505-A at 23° C. and D=6 mm.

The flanged sealing ring is preferably produced based on a polydimethylsiloxane and provided with further fillers, dyeing agents and other components in addition to the metallic fraction.

The flanged sealing ring is preferably dyed with a color to enable better visual recognition in the production process. For example, the flanged sealing ring 13 can be dyed in blue, which is a coloring that occurs rarely especially in the production of foodstuffs. Dyeing with other colors can also be made.

Although the present invention has been described above by means of embodiments with reference to the enclosed drawings, it is understood that various changes and developments can be implemented without leaving the scope of the present invention, as it is defined in the enclosed claims.

### LIST OF REFERENCE NUMERALS

1 Device

2 Pipe

3 Connecting point

4 Metal detector

5 Pipe

6 Detector housing

7 Frame

8 Gate

9 Flap

10 Branch

12 Flange

13 Flanged sealing ring

14 Clamping ring

15 Web

16 Retainer

17 Gap

1-13. (canceled)

14. A flanged sealing ring for sealing a pipe connection, the flanged sealing ring comprising:
a metallic fraction substantially homogeneously in the flanged sealing ring.

15. The flanged sealing ring of claim 14, wherein the metallic fraction is between 0.5% by weight and 10% by weight.

16. The flanged sealing ring of claim 14, wherein metallic particles of the metallic fraction have a maximum size of less than 100μ.

17. The flanged sealing ring of claim 14, wherein the flanged sealing ring has an organic material fraction with polydimethylsiloxane.

18. The flanged sealing ring of claim 14, wherein the flanged sealing ring consists of a material approved for a food sector according to EC Regulations No. 1935/2004 and/or FDA 21 CFR Ch. I, §177.2600.

19. The flanged sealing ring of claim 14, wherein the flanged sealing ring is made from an extruded continuous strand, which is fixed at a seam location by vulcanization.

20. The flanged sealing ring of claim 14, wherein the metallic fraction is iron oxide particles.

21. The flanged sealing ring of claim 14, wherein the flanged sealing ring has a Shore hardness of 50 to 65 KME according to DIN 53505-A at 23° C. and d=6 mm.

22. The flanged sealing ring of claim 14, wherein the flanged sealing ring has a tear strength according to DIN 53504-S1 of 7 to 11 N/mm² at 23° C. and d=2 mm.

23. The flanged sealing ring of claim 14, wherein the flanged sealing ring has an elongation at tear according to DIN 53504-S1 of 300% at 23° C. and d=2 mm.

24. The flanged sealing ring of claim 14, wherein the flanged sealing ring has a rebound resilience according to DIN 53512 of between 40% to 60% at 23° C. and d=12 mm.

25. A pipeline system, comprising:
several pipes forming a pipeline for conveying a flow of material, wherein at least two pipes are held in a sealed manner on each other at a flange via a flanged sealing ring;
a metal detector arranged at the pipeline; and
a gate arranged behind the metal detector in a conveying direction, wherein the gate is arranged to remove a metal-containing substance from the pipeline,
wherein the flanged sealing ring is made from a material with a metallic fraction, so that during detachment of components of the flanged sealing ring the metal detector can detect the detached components, which are discharged at the gate.

26. The pipeline system of claim 25, wherein the flanged sealing ring comprises a web arranged between the flanges of the at least two pipes, and the flanges are held in a clamped manner by a clamping ring.
